(19) United States
(12) Patent Application Publication
(10) Pub. No.: US 2018/0123866 A1
(43) Pub. Date: May 3, 2018

(54) METHOD AND APPARATUS FOR DETERMINING EVENT LEVEL OF MONITORING RESULT

(71) Applicant: SAMSUNG SDS CO., LTD., Seoul (KR)

(72) Inventors: Se Jin KIM, Seoul (KR); Young Woo LEE, Seoul (KR); Hyun Soo KIM, Seoul (KR)

(73) Assignee: SAMSUNG SDS CO., LTD., Seoul (KR)

(21) Appl. No.: 15/798,717

(22) Filed: Oct. 31, 2017

(30) Foreign Application Priority Data
Oct. 31, 2016 (KR) 10-2016-0142766

(51) Int. Cl. H04L 12/24; H04L 12/26

(52) U.S. Cl. CPC H04L 41/0609; H04L 43/16; H04L 41/0613; H04L 41/0893; H04L 41/50; H04L 41/065

(57) ABSTRACT

A method for determining a level of an event includes receiving a monitoring result of a monitoring target, determining whether the monitoring result is an event corresponding to an event classification policy, determining the level of the event based on an event rule policy registered in advance when the monitoring result is determined as the event, determining the monitoring result as a service target event corresponding to the level of the event determined; determining service information and service personnel corresponding to the service target event determined, and transmitting notification information comprising the service information determined to a terminal of the service personnel determined. The service information is determined based on at least one from among monitoring target information matched with the service target event, type of service matched with the monitoring target information, and mapping information of the service target event.

This application claims priority from Korean Patent Application No. 10-2016-0142766 filed on Oct. 31, 2016 in the Korean Intellectual Property Office, the disclosure of which is incorporated herein by reference in its entirety.

### BACKGROUND OF THE INVENTION

### 1. Field of the Invention

The present invention relates to a method and an apparatus for determining an event level of a monitoring result. More particularly, the present invention relates to a method and an apparatus for determining the event level of a system monitoring result, on the basis of a dynamic threshold criterion.

### 2. Description of the Related Art

A monitoring system is used for smooth operation and management of service-based systems. In particular, in service-based systems that provide services of various fields such as portal systems, various monitoring systems may be used, depending on the type of services.

Since such various monitoring systems irregularly generate different types of event messages, it is difficult to determine the importance of the events. This may cause a problem in which a person in charge may not preferentially process important events. Also, in the monitoring system, since the determination criteria for the event does not dynamically change, when the system is upgraded, such as the addition of server equipment, even though this case is not an event target, there is a problem in which the case is erroneously determined as an event in accordance with the existing criteria.

Nevertheless, there has not been a system which registers different types of events in accordance with standardized criteria and classifies the events generated in accordance with such standardized criteria. Also, there has not been a method for generating a dynamic threshold criterion by reflecting the real-time monitoring result of the system to determine the event level in accordance with such a criterion.

### SUMMARY OF THE INVENTION

An aspect of the present invention provides a method and an apparatus for determining the monitoring result as a service target event.

Specifically, an aspect of the present invention provides a method and an apparatus for classifying a monitoring result as a service target event according to an event classification policy, and determining an event level of a service target event.

Another aspect of the present invention provides a method and an apparatus for dynamically generating a threshold criterion on the basis of a monitoring result and determining an event level on the basis of the generated threshold criterion.

Still another aspect of the present invention provides a method and an apparatus for determining service personnel on the basis of a relation between hardware information and service information matched with a service target event.

The aspects of the present invention are not limited to those mentioned above and another aspect which is not mentioned can be clearly understood by those skilled in the art from the description below.

According to an aspect of the inventive concept, there is provided a method for determining an event level performed by an event level determining apparatus, the method comprises receiving a monitoring result of a monitoring target registered in advance, deciding whether the monitoring result is an event according to an event classification policy registered in advance, determining the level of event, on the basis of the event rule policy registered in advance when the monitoring result is determined as the event, determining the monitoring result as a service target event to which the level of the determined event is reflected, determining service information and service personnel on the basis of the determined service target event, transmitting notification information including the service information to the terminal of the determined service personnel, wherein the service information is information which is determined, on the basis of at least one of monitoring target information matched with the service target event, type of service matched with the monitoring target information, and mapping information of the service target event.

According to the present invention described above, there is an effect capable of managing various monitoring results of the monitoring system by a standardized event message.

Also, according to the present invention, there is an advantage that, since the event level can be determined on the basis of the real-time monitoring result, the accuracy of event level is enhanced.

Further, according to the present invention, since it is possible to grasp the importance of an event occurring in a service-based system, there is an effect in which convenience is provided to the service work of the person in charge.

The effects of the present invention are not limited to the effects mentioned above, and another effect which has not been mentioned can be clearly understood by ordinary technicians from the following description.

### BRIEF DESCRIPTION OF THE DRAWINGS

The above and other aspects and features of the present invention will become more apparent by describing in detail exemplary embodiments thereof with reference to the attached drawings, in which:

FIG. 1 is a configuration diagram of a system for determining an event level according to an embodiment of the present invention;

FIG. 2 is a hardware configuration diagram of an apparatus for determining an event level according to another embodiment of the present invention;

FIG. 3 is a flowchart of a method for determining an event level according to another embodiment of the present invention;

FIG. 4 is an exemplary view for explaining functions of an apparatus for determining an event level according to another embodiment of the present invention;

FIG. 5 is a diagram illustrating an example of an event rule referred to in some embodiments of the present invention;

FIG. 6 is a diagram illustrating an example of event classification referred to in some embodiments of the present invention;

FIG. 7 is a flowchart of a method for generating a threshold criterion for determining the event level, which is referred to in some embodiments of the present invention;

FIG. 8 is an exemplary view for explaining a method for determining a service target event according to a threshold criterion, which is referred to in some embodiments of the present invention;

FIG. 9 is a flowchart of a method for determining service information according to another embodiment of the present invention; and

FIG. 10 is an exemplary view for explaining a relation between hardware information and service information matched with a service target event, which is referred to in some embodiments of the present invention.

### DETAILED DESCRIPTION OF THE INVENTION

Hereinafter, preferred embodiments of the present invention will be described with reference to the attached drawings. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms including technical and scientific terms used herein have the same meaning as commonly understood by one of ordinary skill in the art to which this invention belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, the present disclosure will be described in more detail with reference to the accompanying drawings.

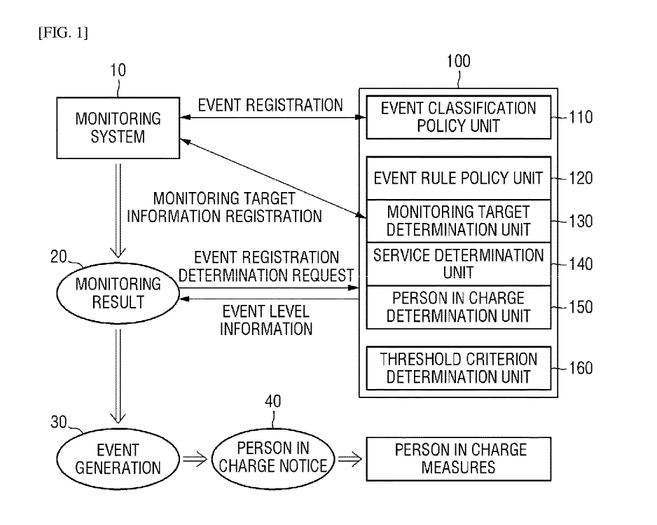

FIG. 1 is a configuration diagram of a system for determining an event level according to an embodiment of the present invention.

Referring to FIG. 1, a system for determining the event level may include one or more monitoring systems 10, an event level determining apparatus 100, and a terminal (not illustrated) of a plurality of service personnel. Also, the system for determining the event level may include one or more service-based systems. The service-based system, for example, may be a mail system, a messenger system, a portal system supporting business of a company.

The monitoring system 10, the event level determining apparatus 100, and the terminals of the plurality of service personnel are computing devices connected to the network and capable of communicating with each other.

The monitoring system 10 may monitor the states of the hardware device included in the event level determination system and the service-based system, the application executed in the service-based system, and the network device/software. A general monitoring system outputs monitoring results 20 of different types, depending on each monitoring target. The monitoring result may be, for example, the monitoring results of the performance of the monitoring target, such as a CPU usage, a memory usage, a memory use pattern, and network status information.

However, the monitoring system 10 according to the embodiment of the present invention may set the generated monitoring result format in the form of an event message suitable for the event classification policy of the event level determining apparatus 100. Therefore, the monitoring system 10 may generate the monitoring result 20 in the form of an event message according to the event classification policy of the event level determining apparatus 100. The monitoring system 10 may provide generated monitoring result 20 to the event level determining apparatus 100 as an event message.

The event level determining apparatus 100 may receive the monitoring result 20 from the monitoring system 10 as an event message. The event level determining apparatus 100 may analyze the monitoring result 20 according to the received event message to determine whether or not an event on the event classification policy occurs. In addition, when the monitoring result 20 corresponds to an event classification policy event, the event level determining apparatus 100 may decide the event level, and may determine (30) the event as a service target event in accordance with the event level. That is, the event may be generated as a final service target event by the event level determining apparatus 100. The service target event means an event which requires measures taken by service personnel.

The monitoring system 10 may request a level determination of the event together with transmission of an event message, and the event level determining apparatus 100 may apply the determined event level to the monitoring result 20.

Hereinafter, the constituent elements of the functional unit of the event level determining apparatus 100 of FIG. 1 will be specifically described.

An event classification policy unit 110 may determine whether the monitoring result according to the received event message is an event according to the event classification policy registered in advance. Further, the event classification policy unit 110 may register an event according to the event classification policy registered in advance in the monitoring system 10. That is, the event classification policy unit 110 normalizes the monitoring result so that the monitoring system 10 outputs the monitoring result as an event message on the event classification policy.

An event rule policy unit 120 may decide the event level. The event rule policy unit 120 may decide the event level by applying the preset rule to the event, and may determine whether or not the event is the service target event. To this end, the event rule policy unit 120 may store information on the threshold criterion for deciding the event level and may decide the event level on the basis of the threshold criterion. When the monitoring result is equal to or higher than the threshold criterion, the event rule policy unit 120 finally determines (30) the event as the service target event.

When the event is determined as the service target event by the event rule policy unit 120, a monitoring target determination unit 130 may determine the monitoring target matched with the service target event. The monitoring target determination unit 130 may determine which event of the monitoring target among a plurality of monitoring targets stored in advance is the service target event. To this end, the monitoring target determination unit 130 may store the monitoring target of the event level determination system, such as a hardware device included in the event level determination system and the service-based system, the application executed in the service-based system, and the network device/software.

The service determination unit 140 may determine measures to be executed for the service target event with respect to the determined monitoring target. In other words, the service information may be solution information for terminating the event of the service target generated for the monitoring target. To this end, the service determination unit 140 may store the service information matched with the monitoring target in advance. The service determination unit 140 may also decide the matching relation between the monitoring target and the service information.

A person in charge determination unit 150 may determine the service personnel who executes the service according to the service information on the basis of the service information. To this end, the person in charge determination unit 150 may store the service personnel information matched with the service information in advance. In addition, the person in charge determination unit 150 may transmit notification information 40 notifying the occurrence of service target event to the terminal of the determined service personnel. The notification information may include level information of the event.

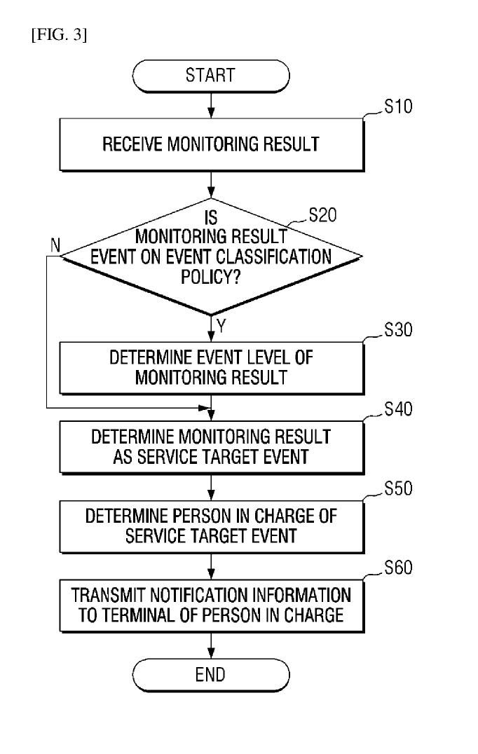

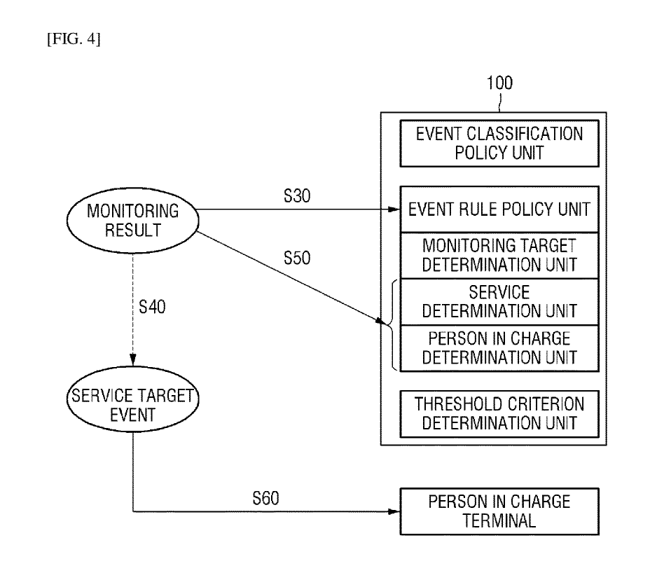

As a result, the person in charge may take measures according to the service information. A detailed description thereof will be given later in the description of FIGS. 3 and 4.

A threshold criterion determination unit 160 may collect the monitoring results for a preset period of time to calculate the statistical results. Accordingly, it is possible to generate a threshold criterion for the event to be monitored. Here, the threshold criterion means a criterion for finally determining an event according to the monitoring result as the service target event by the event level determining device 100.

For example, the threshold criterion determination unit 160 may generate a daily statistical result including a monitoring result received in real time, and may perform a reverse operation on the basis of the daily statistical result to generate a weekly statistical result. Further, the threshold criterion determination unit 160 may also perform a reverse operation on the basis of the daily statistical result to generate statistical results of monitoring results for one month and/or one year. The threshold criterion determination unit 160 may generate a threshold criterion on the basis of at least one of the generated statistical results. The threshold criterion determination unit 160 may also update the previously generated threshold criterion in accordance with reflection of the real-time monitoring result.

Each of the constituent elements according to the functional unit of the event level determining apparatus 100 as described above may mean a unit of module of a software 105 executed by a processor 101 of the event level determining apparatus 100 to be described later. Alternatively, each of the above-described steps and constituent elements may mean a partial region and/or unit of hardware such as a field programmable gate array (FPGA) or an application-specific integrated circuit (ASIC). However, the above-described constituent elements are not limited to software or hardware, but may be configured to be located in a storage medium capable of addressing, and may be configured to execute one or more processors. The functions provided in the above-mentioned constituent elements may be provided by more segmented constituent elements, and a plurality of constituent elements may be combined and implemented as one constituent element that performs a specific function.

On the other hand, the terminal of the service personnel may be one of computing devices such as a smart phone, a laptop computer, a personal digital assistant (PDA), a portable multimedia player (PMP), a navigation device, a slate PC, a tablet PC, and a desktop computer. The terminal of the service personnel may output the notification information 40 which notifies the occurrence of the service target event.

In FIG. 1, the monitoring system 10, the event level determining apparatus 100, and the service-based system are described as different configurations, but the constituent elements of the event level determination system may be configured in a form in which two or more constituent elements are integrated with each other.

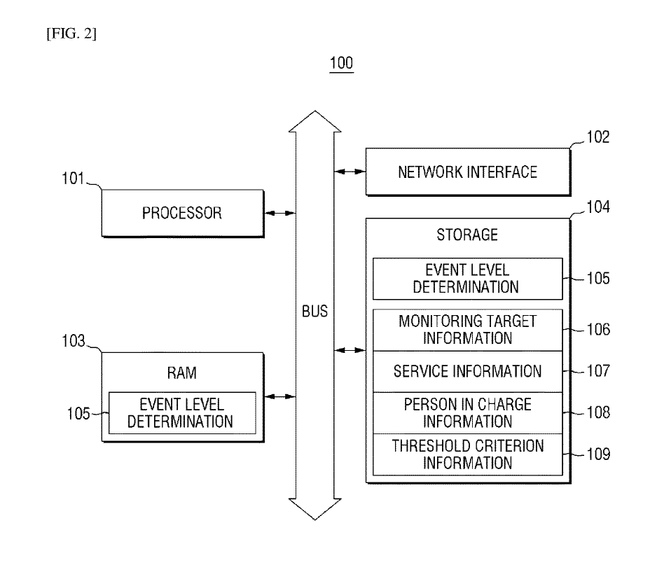

Next, the detailed configuration and operation of the event level device 100 will be described with reference to FIG. 2. FIG. 2 is a hardware configuration diagram of an event level determining apparatus according to another embodiment of the present invention.

Referring to FIG. 2, the event level determining apparatus 100 includes one or more processors 101, a network interface 102, a memory 103 for loading a computer program 105 executed by the processor 101, and a storage 104 for storing the computer program 105.

The processor 101 controls the overall operation of each configuration of the event level determining apparatus 100. The processor 101 may be configured to include a central processing unit (CPU), a micro processor unit (MPU), a micro controller unit (MCU), or any type of processor well known in the technical field of the present invention. Further, the processor 101 may execute the operation of at least one application or program for executing the method according to the embodiments of the present invention. The event level determining apparatus 100 may include one or more processors.

The network interface 102 supports the wired and wireless Internet communication or intranet communication of the event level determining apparatus 100. Also, the network interface 102 may support various communication methods other than Internet communication and intranet communication. To this end, the network interface 102 may be configured to include a communication module well-known in the technical field of the present invention.

The network interface 102 may be connected to the monitoring system and/or service-based system via the network, and may also be connected to the terminal of the service personnel. The network interface 102 may receive the monitoring result and the event message, and may transmit the service target event, and a notification notifying the service target event.

The memory 103 stores various types of data, commands, and/or information. The memory 103 may load one or more programs 105 from the storage 104 so as to execute the method for determining the event level according to the embodiments of the present invention. In FIG. 2, a RAM is illustrated as an example of the memory 103.

The storage 104 may non-temporarily store one or more programs 105. In FIG. 2, an event level determination software 105 is illustrated as an example of the one or more programs 105. In addition, the storage 104 may store various types of information according to the embodiment of the present invention, for example, the monitoring target information 106, the service information 107, the service personnel information 108, and the threshold criterion information 109.

The monitoring target information 106 is information on the target monitored by the monitoring system 10, and may be stored in advance for determining the monitoring target of the monitoring target determination unit 130.

The service information 107 is information on the service requested as a service target event occurs, and may be stored in advance for the determination of the service information of the service determination unit 140.

The service personnel information 108 is information on a person in charge who takes measures according to the service information when a service target event occurs, and may be stored in advance for determining a service personnel of the service personnel determination unit 150.

The threshold criterion information 109 is information on criteria for determining the monitoring result of the monitoring target as a service target event, and may be stored in advance by the threshold criterion generation of the threshold criterion determination unit 160.

The storage 104 may be configured to include a non-volatile memory such as a read only memory (ROM), an erasable programmable ROM (EPROM), an electrically erasable programmable ROM (EEPROM), and a flash memory, a hard disk, an attachable and detachable disk, or a computer-readable recording medium of any form well-known in the technical field to which the present invention belongs.

The event level decision software 105 may perform one or more operations for executing the function and/or measures of the event level determining apparatus 100, by being executed with the processor 101. This will be described later with reference to FIGS. 3 and 4.

Meanwhile, the event level determining apparatus 100 may further include various constituent elements related to the embodiment of the present invention, in addition to the constituent elements illustrated in FIG. 2. For example, the event level determining apparatus 100 may include an output unit for notifying an occurrence of a service target event to a system administrator, and an input unit for receiving setting of the threshold criterion, the input of the monitoring target, the input of the event rule, and the event classification policy from the administrator.

FIG. 3 is a flowchart of a method for determining an event level according to another embodiment of the present invention. FIG. 4 is an exemplary view for explaining functions of an event level determining apparatus according to another embodiment of the present invention. The description of each configuration of the event level determining apparatus 100 of FIG. 4 will be omitted in the range which overlaps the description of the above-described constituent elements in FIGS. 1 and 2.

Hereinafter, the operation of the event level determining apparatus 100 will be described in more detail with reference to FIGS. 3 and 4. Each of the following steps is assumed to be executed by the event level determining apparatus 100.

Referring to FIGS. 3 and 4, the event level determining apparatus 100 may receive the monitoring result of the monitoring target registered in advance (S10). The event level determining apparatus 100 may receive the monitoring result from the monitoring system. At this time, the event level determining apparatus 100 may also receive the real-time monitoring result of the monitoring target. Specifically, the event level determining apparatus 100 may receive the monitoring result as an event message.

The event level determining apparatus 100 may determine whether the monitoring result is an event according to an event classification policy registered in advance (S20). When the monitoring result is determined as an event on the event classification policy registered in advance, the event level determining apparatus 100 may decide the event level on the basis of the event rule policy registered in advance (S30).

Specifically, the event level determining apparatus 100 may determine whether the data on the event message received by the event classification policy unit conforms to the event policy. As a result, the event level determining apparatus 100 may determine whether the monitoring result according to the received event message is the event according to the embodiment of the present invention.

If the monitoring result is determined as an event, the event level determining apparatus 100 may determine the event level, using the event rule policy unit.

On the other hand, when the monitoring result is not determined as an event on the event classification policy registered in advance, the event level determining apparatus 100 may transmit the monitoring result to the terminal of the service personnel. At this time, the event level determining device 100 may determine whether there is service information and/or service personnel information matched with the monitoring result that is not determined to be an event on the event classification policy. In accordance with such determination result, the event level determining apparatus 100 may convert the monitoring result into an event message or generate an event message including the service information matched with the monitoring result. Also, the event level determining apparatus 100 may send the generated event message to the terminal of the matched service personnel.

Next, the event level determining apparatus 100 may determine the monitoring result as the service target event to which the level of the decided event is reflected (S40). At this time, the event level determining apparatus 100 may determine the event level, on the basis of the threshold criterion generated using the monitoring result of the preset period of time.

Specifically, the event level determining apparatus 100 may compare the monitoring result with the threshold criterion to decide the event level in accordance with the section to which the comparison result belongs.

For example, when the monitoring target is the memory usage, if the memory usage of 10% or more than the threshold criterion is monitored, the event level determining apparatus 100 may determine the event level as warning, and if the memory usage of 20% or more than the threshold criteria is monitored, the event level determining apparatus 100 may determine the event level as urgency. Further, when the memory usage of 30% or more than the threshold criterion is monitored, the event level determining apparatus 100 may determine the event level as failure. On the other hand, if the memory usage is 5% or more or less than the threshold criterion, the event level determining apparatus 100 may determine the event level as normality. The section may be set in advance by the administrator of the event level determining apparatus 100.

According to another embodiment of the present invention, the above level may be determined by grade through comparison of the monitoring result with the level on the table of the event rule, and may also be expressed numerically in accordance with the upper limit and the lower limit of the threshold criterion and the detailed comparison result.

The event level determining apparatus 100 may determine service information and service personnel on the basis of the determined service target event (S50). At this time, the service target event may be matched with at least one of service information and service personnel information.

The event level determining apparatus 100 may identify the terminal information of the determined service personnel and may send the notification information including the service information to the terminal (S60). For example, the notification information may include service information and level information of the event, as a message which notifies occurrence of a service target event.

Meanwhile, according to the embodiment of the present invention, the service information may be information determined on the basis of at least one of the monitoring target information matched with a service target event, and the mapping information of the service type and the service target event matched with the monitoring target information. The mapping information of the service target event may be information of the application extracted from the service target event.

For example, when an error of software occurs as a service target event from the mail server, the mapping information may be information of the mail application. In this case, the event level determining apparatus 100 may determine the service information on the basis of the information of the mail application. Further, the event level determining apparatus 100 may determine the person in charge of the mail application on the basis of the information of the determined service, and may transmit the notification of the service target event to the terminal of the person in charge.

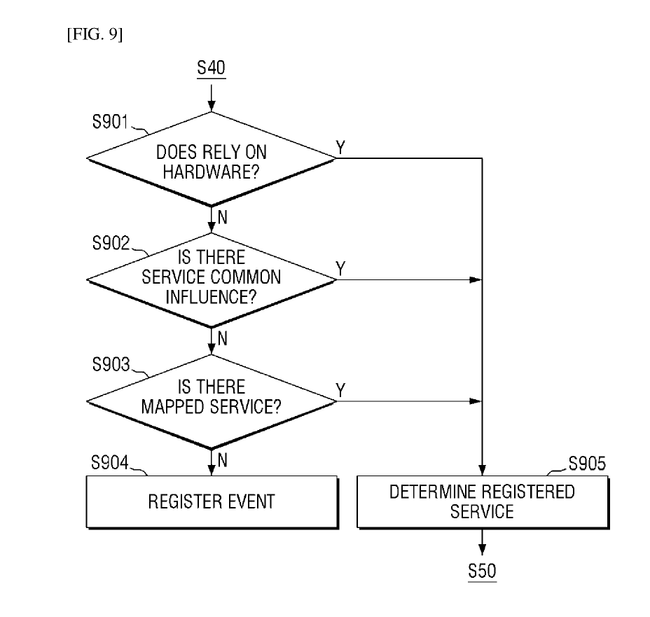

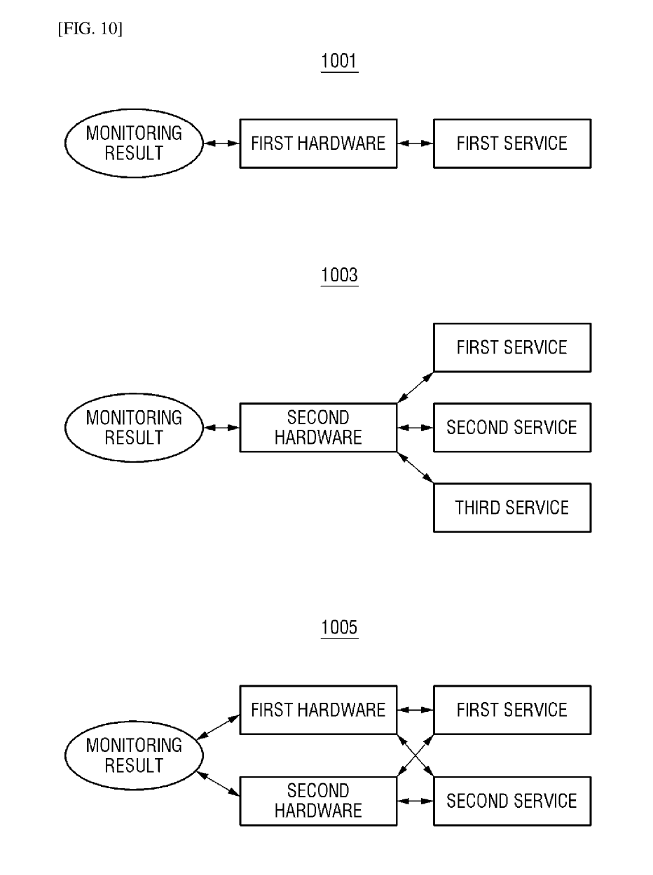

The method for determining the service information will be described later in detail with reference to FIGS. 9 and 10.

Meanwhile, in step S60, the event level determining apparatus 100 may determine the priority of the notification information to be transmitted, on the basis of the level of the determined event. For example, in the event level determining apparatus 100, the priority of the notification information 2 in which the level is urgent may be determined to be higher than the notification information 1 in which the level is warning.

In this case, on the basis of the determined priority, the event level determining apparatus 100 may determine at least one of the contents of the notification information, the number of times of transmission, and the transmission period. In the above example, the notification information 2 may include the display and the color of the emergency level as contents, and the notification information 1 may include the display and the color of the warning level as the contents. Further, in the case of notification information 2, the number of times of transmission may be determined three times per minute, and in the case of notification information 1, the number of times of transmission may be determined once per minute. Also, the notification information 2 may be determined to last for 30 minutes, and the notification information 1 may be determined to last for 10 minutes.

On the basis of such determination matters, the event level determining apparatus 100 may transmit the notification information to the terminal of the service personnel.

Next, the description will be given of a case where, after the notification information is received by the terminal of the service personnel from the event level determining apparatus 100, the service target event is terminated.

The first case is a case of automatic termination according to resolution of an event.

After the event level determining apparatus 100 transmits the notification information to the terminal of the service personnel, the event level determining apparatus 100 may continue to receive the monitoring result. At this time, if the received monitoring result is equal to or smaller than the threshold criterion, the event level determining apparatus 100 may automatically terminate the service target event. As the service target event is terminated, additional notification notice is not sent to the terminal of the service personnel.

For example, this is a case where the event level of the service target event is changed to a normal level from an emergency or warning. This may be a case where a temporary error occurs in the monitoring target of the system or the usage of the monitoring target rapidly increases instantaneously, but there is no error in a monitoring target and measures of the person in charge are not required. In such a case, according to the embodiment of the present invention, there is an advantage that work efficiency of service personnel can be improved by not frequently sending unnecessary event messages to the terminal of service personnel.

The second case is a case where the event was not resolved, but it was automatically terminated.

After the event level determining device 100 may determine whether the event has terminated after sending the notification information to the terminal of the service personnel. When the service personnel takes measures according to the service information or the service target event is automatically terminated as in the first case, the event may be terminated.

As a result of the determination as to whether or not the event is terminated, if the service target event is not terminated during the preset period of time, the event level determining apparatus 100 may automatically terminate the service target event. This may be a case where the service personnel are sufficiently familiar with the service target event, but it is difficult to solve the service target event.

For example, when a preset time is set to 30 minutes, the service personnel may be sufficiently familiar with the situation of the service target event. Even in such a case, the reason why the service target event is not terminated is that resolution of the service target event is delayed. Thus, it is not necessary to continuously send the notification notice to the terminal of the service personnel. Therefore, when the preset time has elapsed, the event level determining apparatus 100 may automatically terminate the service target event. As the service target event is terminated, no additional notification notice is sent to the terminal of the service personnel.

The third case is a manual case corresponding to the measures of the service personnel.

The service personnel receives the notification notice via the terminal, and may take measures on the monitoring target, on the basis of the service information on the notification notice. Thus, when the measure result of the service personnel is registered in the event level determining apparatus 100, the event level determining apparatus 100 may terminate the service target event.

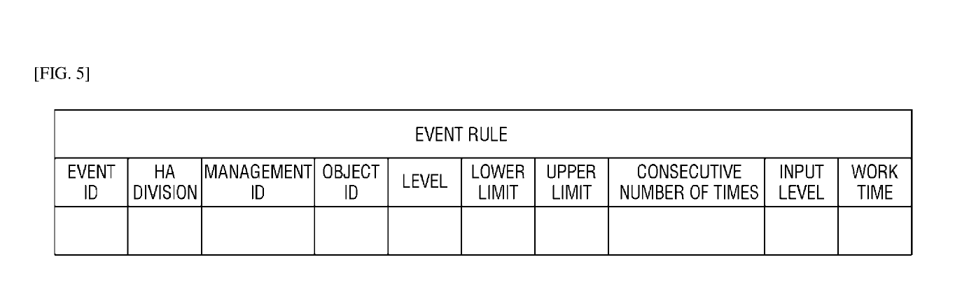

FIG. 5 is an example of an event rule referred to in some embodiments of the present invention.

Referring to FIG. 5, the event rule is a table for determining the event level and deciding the event as the service target event.

For example, the event rule may include a column, such as an event ID, an HA classification, a management ID, an object ID, a level, a threshold criterion (lower limit, and upper limit), a consecutive number of times, an input level, and a work time.

The event ID means the event ID according to the event classification policy. The HA classification means hardware information of the monitoring target. That is, the HA classification is information as to whether it is a single hardware device, HA configuration hardware, or cluster hardware.

The management ID is an ID of the monitoring target, and may be a hardware ID or a network ID. The object ID may be information on the process and the directory. This is for identifying the application in service.

The level means the event level, the upper limit and the lower limit indicate the range of the threshold criterion, and the consecutive number of times is the continuous reception number of times of the event message.

The work time is a criterion for deciding whether an event occurs during work time. For example, the event level determining apparatus 100 may determine the event level occurring out of the work times to be relatively low, and may determine the event level occurring during the work time to be relatively high.

The input level may have a numerical value, for example, as an event according to the received monitoring result.

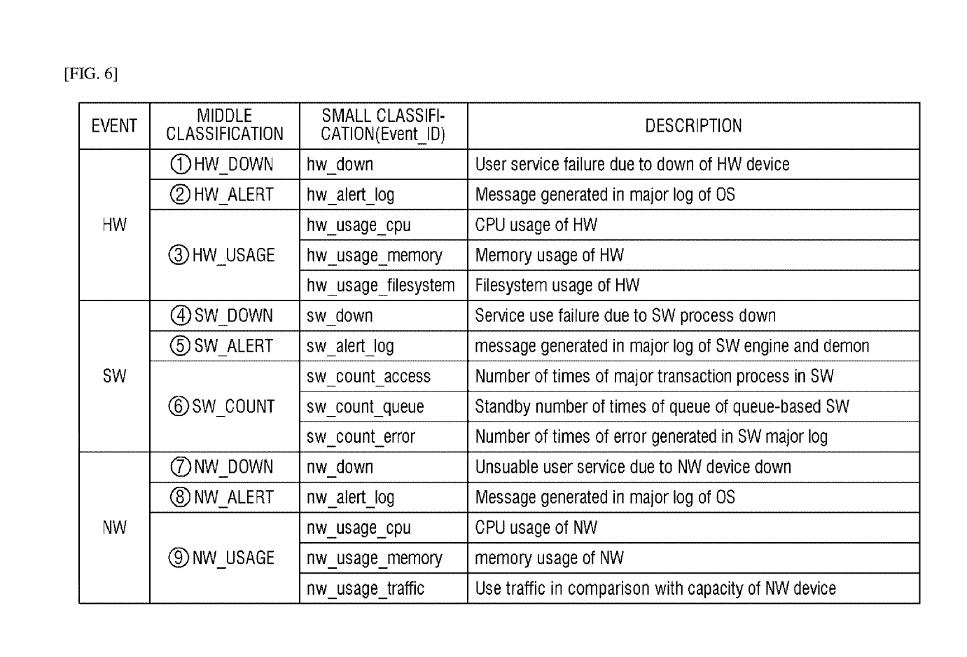

FIG. 6 is an example of event classification referred to in some embodiments of the present invention.

FIG. 6 is an example of an event classified as an event in accordance with a preregistered event classification policy according to an embodiment of the present invention. Referring to FIG. 6, for example, the events are classified into hardware, software, and networks as large classification, and are classified into service fault status, warning status, and usage event as medium classifications. The usage event is classified into the usage of memory, the CPU, and file system as a small classification in the case of hardware. In the case of software, the usage event is classified into the number of times of queue standby, the number of times of major transactions, and the number of times of error occurrences. In the case of software, the usage event may be classified into CPU usage, memory usage, and traffic being using in comparison with resource.

The embodiment of the present invention is not limited to the example of the event rule of FIG. 5 and the event example according to the event classification of FIG. 6.

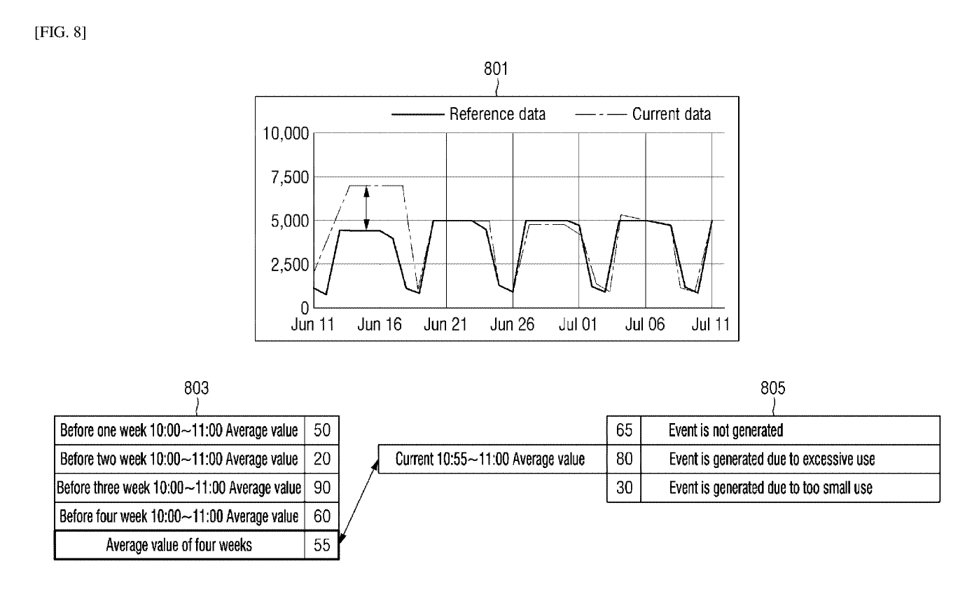

In step S30, the event level determining apparatus 100 may decide the level of event, on the basis of the threshold criterion generated using the monitoring result collected during the preset period of time. Hereinafter, a method for generating a threshold criterion using the monitoring result will be specifically described. A process of determining the service target event according to the threshold criterion in step S40 will be described with reference to FIG. 8 as an example.

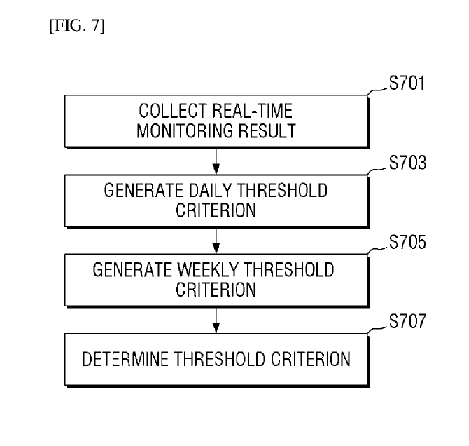

FIG. 7 is a flow chart of a method for generating a threshold criterion for determining the event level, referred to in some embodiments of the present invention. FIG. 8 is an exemplary view for explaining a method for determining the service target event according to a threshold criterion referred to in some embodiments of the present invention.

Referring to FIG. 7, in step S10, the event level determining apparatus 100 may collect the monitoring results in real time (S701). At this time, the event level determining apparatus 100 may generate the first threshold criterion, on the basis of the monitoring result collected during the first period of time including the time point at which the monitoring result is collected (S703 and S705).

For example, the first period of time may be a period of one day or a period of one month obtained by reverse-operation from the time point at which the monitoring result is collected. When the first period of time is a period of one day, the event level determining apparatus 100 may generate a first threshold criterion, on the basis of the monitoring results collected during the above-mentioned period of one day (S703). When the first period of time is a period of one month, the event level determining apparatus 100 may generate the first threshold criterion, on the basis of the monitoring result collected during the period of one month (S705).

The event level determining apparatus 100 may determine the threshold criterion for determining the event level decision and/or event as the service target event, by the first threshold criterion generated in the steps (S703 and S705). The first threshold criterion is a threshold criterion to which the real-time monitoring result described above is reflected. In other words, the first threshold criterion is a threshold criterion in which the event level determining apparatus 100 calculates statistics on the monitoring results up to the time point at which the above-mentioned monitoring result is collected as the inverse operation start point of one day or one month, and which is determined by the event level determining apparatus 100 on the basis of the calculated statistical result.

Further, according to the embodiment of the present invention, the event level determining apparatus 100 may change the second threshold criterion generated on the basis of the monitoring result collected during the second period of time, which is a period before the time point at which the monitoring result is collected, to the first threshold criterion.

Here, the second period of time is the period of time before the monitoring result is reflected, and the monitoring result during the second period of time does not reflect the real-time monitoring result. For example, if the time point at which the real-time monitoring result is collected is defined as the first time point, the second period of time may be a predetermined period before the first time point. Alternatively, the second period of time may be a predetermined period of time before the one day period of time obtained by the reverse-operation from the first time point. Alternatively, the second period of time may be a predetermined period of time before the one month period obtained by the reverse-operation from the first time point.

Before the first threshold criterion reflecting the monitoring result at the first time point is generated, the event level determining apparatus 100 may store the second threshold criterion which reflects the monitoring result up to the second period of time in advance.

The event level determining apparatus 100 may change the threshold criterion from the second threshold criterion to the first threshold criterion as the first threshold criterion is generated.

As a result, the event level determining apparatus 100 may not determine the event determined as the service target event in accordance with the second threshold criterion, as the service target event in accordance with the first threshold criterion.

For example, it is assumed that software is updated at the first time point or server equipment is added. In this case, the performance of the service-based system may be improved, and the event level determining apparatus 100 may collect the monitoring result in real time, calculate the statistics, and generate the first threshold criterion. According to the first threshold criterion, it is assumed that the level of a specific event is determined as a normal level. As a result, the specific event is not determined as the service target event.

On the other hand, if the second threshold criterion is generated in advance as the event level determination criterion before the first time point, according to the second threshold criterion, the level of the specific event is assumed to be determined as the warning level. In this case, the specific event will be determined as the service target event.

Referring to FIG. 8, a graph 801 is an example of memory usage, as a monitoring result associated with execution of a specific application of a service-based system.

The event level determining apparatus 100 may generate a threshold criterion for comparison with the real-time monitoring result of the current time point for each time period. Referring to the threshold criterion 803 of FIG. 8, the average memory usage was calculated on a weekly basis, and the average memory usage for four weeks was calculated on the basis thereof. The average memory usage 55 for the four weeks may be determined as a threshold criterion.

Referring to the determined service target event information 805, the event level determining apparatus 100 does not determine the event as the service target event, when the memory usage is 65 in comparison with the threshold criterion 55 and exhibits a small amount of difference.

On the other hand, when the memory usage is 80 in comparison with the threshold criterion 55 and is excessively used, or when the memory usage is 30 and is too small, the event level determining apparatus 100 may determine the event as a service target event.

FIG. 9 is a flowchart of a method for determining service information according to another embodiment of the present invention. FIG. 10 is an exemplary view for explaining a relation between hardware information and service information matched with a service target event, which is referred to in some embodiments of the present invention.

Hereinafter, when the monitoring result is determined as a service target event in step S40, the method for determining service information according to the three cases (1001, 1003, and 1005) of FIG. 10 will be specifically described referring to the flowchart of FIG. 9.

The first case (1001) is a case where the monitoring target information matched with the service target event is the first hardware information, and the service information matched with the first hardware information is the first service information. The case where the first hardware information is the first hardware will be described as an example.

At this time, the event level determining apparatus 100 may determine whether the service target event depends on the first hardware (S901). That is, this is a case where the service target event occurs only on specific hardware. For example, it is assumed that the first hardware is a mail server, and the mail server provides only a mail application. A case where an error is determined as a service target event in the mail application is a case where a problem occurs in the mail server. In this case, the service information may be a request to remove the failure of the mail server, and the service personnel may be an administrator of the mail server.

The event level determining apparatus 100 may identify the first hardware information matched with the service target event. Also, when the service target event depends on the first hardware in step (S901), the event level determining apparatus 100 determines the service information matched with the first hardware (S90), and may determine service personnel information in step (S50).

In step (S901), when the service target event does not depend on the first hardware, the event level determining apparatus 100 may determine whether the first hardware information matched with the service target event has a common influence on a plurality of pieces of service information (S902).

Hereinafter, referring to the second case 1003, a case where the first hardware information matched with the service target event has a common influence on a plurality of pieces of service information will be described. The second case (1003) is a case where the monitoring target information matched with the service target event is the first hardware information, and the service information matched with the first hardware information includes a plurality of pieces of service information. The case where the first hardware information is the second hardware will be described as an example.

In step (S902), it is assumed that, in the event level determining device 100, the second hardware is a portal system server, and the portal system server provides the mail application, the messenger application, and the portal web browser application. Also, in case (1003), it is assumed that the service information of the mail application is registered as a first service, the service information of the messenger application is registered as a second service, and the service information of the portal web browser application is registered as a third service in advance.

The event level determining device 100 may identify the application mapped to the service target event. For example, the event level determining apparatus 100 may identify that the service target event occurs in the portal system server and the mapped application is an application of a messenger.

By identifying the application of the messenger, the event level determining apparatus 100 may determine the service information as the second service, among the first service, the second service and the third service (S905).

In step S902, if the first hardware information matched with the service target event does not have a common influence on the plurality of pieces of service information, the event level determining apparatus 100 may determine whether there is a service mapped to the service target event (S903).

Hereinafter, a case where there is a service mapped to a service target event will be described referring to the third case (1005). The third case (1005) is a case where the monitoring target information matched with the service target event includes the first hardware information and the second hardware information, and the service information matched with each of the first hardware information and the second hardware information includes one or more pieces of service information.

The description will be given of a case where the first hardware information is first hardware and the second hardware information is second hardware as an example. It is assumed that the first hardware and the second hardware are a game service providing server, and separately provide a settlement service application of each item and a chat service application between game users. Further, it is assumed that, in the case (1005), the service information of the settlement service application is registered as a first service in advance, and the service information of the chat service application is registered as a second service in advance.

In this case, the event level determining apparatus 100 may identify the service application mapped to the service target event. For example, the event level determining apparatus 100 may identify that the service target event occurs in the game service providing server of the first hardware and the mapped service application is the settlement application.

By identifying the application of the settlement service, the event level determining apparatus 100 may determine the service information as the first service among the first service and the second service (S905).

As the first service is determined, the event level determining apparatus 100 may determine settlement service personnel of the first hardware as a service personnel (S50).

On the other hand, when there is no service mapped to the service target event, the event level determining apparatus 100 registers the service target event as a new service target event. As a result, the event level determining apparatus 100 may newly register the monitoring target and the service information of the in the service target event.

The embodiments of the present invention described with reference to FIGS. 3 to 10 may be implemented as a computer-readable code on a computer-readable medium. The computer-readable recording medium may be, for example, a mobile recording medium (a CD, a DVD, a Blu-ray disc, a USB storage device, and a mobile hard disc) or a fixed type recording medium (a ROM, a RAM, a computer with a hard disc). The computer program recorded in the computer-readable recording medium may be transmitted to other computing devices via a network such as Internet and may be installed on the other computing devices, and thus, the computer program may be used in other computing devices.

Also, although the operations are illustrated in a particular order in the drawings, it is not to be understood that the operations are necessarily to be performed in a particular illustrated order, or in sequence, or all the illustrated operations are to be performed in order to obtain the desired results. Under particular circumstances, multitasking and parallel processing may be advantageous. Also, in the above embodiments, the separation of the various configurations is not to be understood that such separation is necessarily required, and it should be understood that the described program components and systems may be integrated together in a single software product and may be packaged in numerous software products.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A method for determining a level of an event, the method comprising:
receiving a monitoring result of a monitoring target;
determining whether the monitoring result is an event corresponding to an event classification policy;
determining the level of the event based on an event rule policy registered in advance when the monitoring result is determined as the event;
determining the monitoring result as a service target event corresponding to the level of the event determined;
determining service information and service personnel corresponding to the service target event determined; and
transmitting notification information comprising the service information determined to a terminal of the service personnel determined,
wherein the service information is determined based on at least one from among monitoring target information matched with the service target event, type of service matched with the monitoring target information, and mapping information of the service target event.

2. The method of claim 1, wherein determining the level of the event comprises:
generating a threshold criterion using monitoring results collected during a preset period of time; and
determining the level of the event based on the threshold criterion generated.

3. The method of claim 2, wherein generating the threshold criterion comprises:
generating a first threshold criterion based on the monitoring result collected during a first period of time comprising a time point at which the monitoring result is collected; and
changing a second threshold criterion, generated based on the monitoring result collected during a second period of time, to the first threshold criterion prior to the monitoring result being collected.

4. The method of claim 3, wherein the event is not determined as the service target event when determining the level of the event based on the first threshold criterion, and
the event is determined as the service target event when determining the level of the event based on of the second threshold criterion.

5. The method of claim 2, wherein transmitting the notification information comprising the service information comprises:
automatically terminating the service target event when the monitoring result received is equal to or less than the threshold criterion after transmitting the notification information to the terminal of the service personnel.

6. The method of claim 1, wherein transmitting the notification information comprising the service information comprises:
determining priority of the notification information to be transmitted based on the level of the event determined;
determining at least one from among contents of the notification information, number of times of transmission of the notification information, and transmission period of the notification information, based on the priority determined; and
transmitting the notification information to the terminal of the service personnel based on the determination.

7. The method of claim 1, wherein transmitting the notification information comprising the service information comprises:
automatically terminating the service target event when the service target event is not terminated during a preset period of time after transmitting the notification information to the terminal of the service personnel.

8. The method of claim 1, wherein, when the monitoring target information matched with the service target event is first hardware information and the service information matched with the first hardware information is first service information,
determining the service information and the service personnel comprises:
determining the service information as first service information matched with the first hardware information.

9. The method of claim 1, wherein, when the monitoring target information matched with the service target event is a first hardware information and the service information matched with the first hardware information comprises a plurality of pieces of service information,
determining the service information and the service personnel comprises:
determining the service information as any one of service information corresponding to an application mapped to the service target event among the plurality of pieces of service information.

10. The method of claim 1, wherein, when the monitoring target information matched with the service target event comprises first hardware information and second hardware information, and service information matched with each of the first hardware information and the second hardware information comprises one or more pieces of service information,
determining the service information and the service personnel comprises:
determining the service information as any one of service corresponding to an application mapped to the service target event, among one or more pieces of service information matched with each of the first hardware information and the second hardware information.

11. An apparatus for determining a level of an event, the apparatus comprising:
a processor configured to execute instructions to:
receive a monitoring result of a monitoring target and determine whether the monitoring result is an event corresponding to an event classification policy;
determine a level of the event based on an event rule policy registered in advance, and determine the monitoring result as a service target event corresponding to the level of the event determined, when the monitoring result is determined as the event; and
determine service information and a service personnel based on the service target event determined, and transmit a notification information comprising the service information to a terminal of the service personnel determined,
wherein the service information determined based on at least one from among monitoring target information matched with the service target event, type of service matched with the monitoring target information, and mapping information of the service target event.

12. A computer program combined with a computing device and stored in a recording medium for executing:
receiving a monitoring result of a monitoring target;
determining whether the monitoring result is an event corresponding to an event classification policy;
determining a level of the event based on an event rule policy registered in advance when the monitoring result is determined as the event;
determining the monitoring result as a service target event corresponding to the level of the event determined;
determining service information and service personnel based on the service target event determined; and
transmitting a notification information comprising the service information to a terminal of the service personnel determined,
wherein the service information is determined based on at least one from among monitoring target information matched with the service target event, type of service matched with the monitoring target information, and mapping information of the service target event.

13. The apparatus of claim 11, wherein the processor is further configured to:
generate a threshold criterion using monitoring results collected during a preset period of time; and
determine the level of the event based on the threshold criterion generated,
wherein generating the threshold criterion comprises generating a first threshold criterion based on the monitoring result collected during a first period of time comprising a time point at which the monitoring result is collected, and changing a second threshold criterion, generated based on the monitoring result collected during a second period of time, to the first threshold criterion prior to the monitoring result being collected.

14. The apparatus of claim 13, wherein the event is not determined as the service target event when determining the level of the event based on the first threshold criterion, and the event is determined as the service target event when determining the level of the event based on the second threshold criterion.

15. The apparatus of claim 13, wherein the processor is further configured to automatically terminate the service target event when the monitoring result received is equal to or less than the threshold criterion after transmitting the notification information to the terminal of the service personnel.

16. The apparatus of claim 11, wherein the processor is further configured to:
determine priority of the notification information to be transmitted based on the level of the event determined.

17. The apparatus of claim 11, wherein the processor is further configured to automatically terminate the service target event when the service target event is not terminated during a preset period of time after transmitting the notification information to the terminal of the service personnel.

18. The apparatus of claim 11, wherein, when the monitoring target information matched with the service target event is first hardware information and the service information matched with the first hardware information is first service information,
the processor is further configured to determine the service information as first service information matched with the first hardware information.

19. The apparatus of claim 11, wherein, when the monitoring target information matched with the service target event is a first hardware information and the service information matched with the first hardware information comprises a plurality of pieces of service information,
the processor is further configured to determine the service information as any one of service information corresponding to an application mapped to the service target event among the plurality of pieces of service information.

20. The apparatus of claim 11, wherein, when the monitoring target information matched with the service target event comprises first hardware information and second hardware information, and service information matched with each of the first hardware information and the second hardware information comprises one or more pieces of service information,
the processor is further configured to determine the service information as any one of service corresponding to an application mapped to the service target event, among one or more pieces of service information matched with each of the first hardware information and the second hardware information.
